(19) United States
(12) Patent Application Publication
(10) Pub. No.: US 2010/0047508 A1
(43) Pub. Date: Feb. 25, 2010

(54) OPTICAL STORAGE DEVICE HAVING LIMITED-USE CONTENT AND METHOD FOR MAKING SAME

(75) Inventor: Marc Brian Wisnudel, Glen Rock, NJ (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/604,834

(22) Filed: Oct. 23, 2009

Related U.S. Application Data
(62) Division of application No. 11/290,243, filed on Nov. 30, 2005.

(51) Int. Cl. B32B 3/02; B05D 5/06

(52) U.S. Cl. 428/64.8; 427/162

(57) ABSTRACT

The invention relates generally to optical storage devices, such as DVDs and CDs, on which compositions containing dyes are disposed so as to facilitate limited or selective use of at least a portion of the content of the optical storage devices. The invention also relates to methods of making limited-use content optical storage devices.

### CROSS-REFERENCE

This application is a divisional of application Ser. No. 11/290,243, filed 30 Nov. 2005, which is hereby incorporated by reference herein in its entirety.

### BACKGROUND

The invention relates generally to optical storage devices, such as DVDs and CDs, on which compositions containing dyes are disposed for facilitating limited or selective use of at least a portion of the content of the optical storage devices. The invention also relates to methods of making limited-use content optical storage devices.

Portable optical storage devices such as CDs and DVDs have attained a large consumer market in recent years. As such, there has been much effort to improve the technology and for companies to gain a competitive advantage. Along that vein, recently ways have been sought to prevent unauthorized copying of the data stored on these devices, without significantly hindering authorized use of these devices.

For example, U.S. Pat. Nos. 5,815,484, 6,589,626, and 6,638,593 all disclose optical storage media having a copy protection feature, and methods for fabricating such media. These patents utilize a similar technology as used in recordable and rewritable storage media, namely the use of dye, phase-change, and other chemical compounds that change their molecular state when irradiated with light. In most cases of rewritable media, however, the chemical compounds typically revert to their original molecular state when exposed to light and/or heat. The '626 and '593 patents, for example, describe dye compounds that change molecular states and revert quickly, but still more slowly than the timescale of the media readers.

Others have described optical storage media containing dye compounds that change molecular state and do not quickly revert after exposure, such as U.S. Patent Application Publication No. 2003/0081521 A1 and International Publication No. WO 99/41738. For example, the '521 application discloses DVDs containing phthalocyanines or naphtholocyanines. However, the '521 publication discloses uses for these state-changeable materials other than mere copy protection; it discloses methods in which specific content stored on the optical media can be limited-use. Nevertheless, it has been found that phthalocyanine and naphtholocyanine dyes offer very little inclination to change state when exposed to energy from a conventional DVD player (reader), which amounts to a 5-10 mW laser at 650 nm.

Many dyes, like those threshold dyes of the '521 publication, require a high intensity (e.g., greater than 50 mW) to exhibit a state change. Further, the observed change can be undesirable, such as when the dyes have been changed in state by exposure to 650 nm energy but effectively change state for wavelengths at significantly higher wavelengths, e.g., ˜700 nm or so. Furthermore, the addition of dyes such as phthalocyanine and naphtholocyanine dyes can cause permanent parity and/or read errors on the optical media, even upon a change of state or a reversion, which is highly undesirable.

It would therefore be desirable to develop an optical storage device, and a method for making it, containing a dye that changes optical properties relatively quickly, that does so under only a few repeated exposures to relatively low intensity energy, that does so at approximately the same wavelength as the energy applied, and that does not introduce significant errors to the storage device by its addition thereto. Any one or more of these goals can be attained by the products and methods disclosed herein, as set forth below.

### SUMMARY

In accordance with one embodiment of the invention, there is provided an optical storage device on which at least some limited-use data is stored. The optical storage device includes a storage layer on which data is stored, a content access layer covering at least a portion of the data stored on the storage layer, a coating layer capable of protecting the storage layer and the data stored thereon, and an optically transparent layer through which the stored data from the storage layer can be accessed.

In one aspect, the content access layer comprises a film made from a dye composition comprising a diluent and a dye compound, which comprises a xanthene, a thiazine, an oxazine, a fluorone, or the like, or a combination thereof, more preferably a xanthene having the following formula:

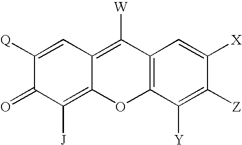

where W is hydrogen, a substituted phenyl group, or a cyano group, J, Q, X, and Y are independently hydrogen or iodine, and Z is a hydroxyl group, a C₁-C₆ alkoxy group, or a hydroxy-(C₁-C₆ alkoxy) group. In another aspect, the dye compound exhibits a measurable change in optical properties upon not more than about 100 seconds of direct exposure to a light source emitting wavelengths from about 635 nm to about 650 nm at an intensity from about 5 mW to about 10 mW.

In accordance with another embodiment of the invention, a method of fabricating a limited-use optical storage device is provided. The method includes (a) depositing a content access layer comprising a dye composition on a read surface of a pre-fabricated optical storage device, (b) optionally depositing a second optically transparent layer upon the content access layer, (c) selectively exposing at least a portion of the dye composition of the content access layer to one or more characteristic wavelengths of energy emitted by an optical storage device data reader system for a sufficient time to effect a change in optical properties, and (d) forming at least one region on the optical storage device that is interpreted as a read error, a parity error, or both by the optical storage device data reader system. In an aspect, the dye compound exhibits a measurable change in optical properties upon not more than about 100 seconds of direct exposure to a light source emitting wavelengths from about 635 nm to about 650 nm at an intensity from about 5 mW to about 10 mW.

In accordance with another embodiment of the invention, a method of fabricating a limited-use optical storage device is provided. The method includes providing a storage layer on which data is stored, providing a coating layer capable of protecting the storage layer and the data stored thereon, providing an optically transparent layer through which the stored data from the storage layer can be accessed, and depositing a content access layer covering at least a portion of the data stored on the storage layer. The method further includes selectively exposing at least a portion of the dye composition of the content access layer to one or more characteristic wavelengths of energy emitted by an optical storage device data reader system for a sufficient time to effect a change in optical properties and forming at least one region on the optical storage device that is interpreted as a read error, a parity error, or both by the optical storage device data reader system. In an aspect, the dye compound exhibits a measurable change in optical properties upon not more than about 100 seconds of direct exposure to a light source emitting wavelengths from about 635 nm to about 650 nm at an intensity from about 5 mW to about 10 mW.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 shows a cross-section perspective of an optical storage device, as described herein, in which a content access layer and an optically transparent layer are added to a pre-fabricated optical storage device.

FIG. 2 shows a cross-section perspective of an optical storage device, as described herein, in which a content access layer is placed between a storage layer and an optically transparent layer.

FIG. 3 shows a cross-section perspective of an optical storage device, as described herein, having first and second storage layers, in which a content access layer is disposed anywhere between the first storage layer and the external surface of the optical storage device that is to be exposed to energy from an optical data reader system.

FIG. 4 shows a top view perspective of a DVD, as in FIG. 1, where the content access layer was spin-coated onto the pre-fabricated and a mask was used to photobleach all but three spots on the content access layer.

FIG. 5 shows a flow chart for making an optical storage device such as pictured in FIGS. 1 and 4.

FIG. 6 shows a flow chart for making an optical storage device such as pictured in FIG. 2.

### DETAILED DESCRIPTION OF PREFERRED EMBODIMENTS

Optical storage devices, as described herein, are typically those that store information capable of being accessed using optical data reader systems including light sources such as visible lasers, UV lasers, infrared lasers, or the like, and detectors therefor. As used herein, the term “optical”, with reference to optical storage devices and optical data reader systems, means that the information stored thereon and/or retrieved thereby utilizes wavelengths from about 100 nm to about 1 micron, preferably from about 200 nm to about 850 nm. In certain embodiments, the term “optical” refers to wavelengths of light that is visible to the human eye, or those from about 370 nm to about 800 nm.

While the optical storage devices described herein generally involve optical storage and are typically in read-only format, the invention is not limited thereto, as, e.g., writable and/or re-writable format optical storage devices may also be used. Examples of optical storage devices, as described herein, can include, but are not limited to, DVDs such as DVD-5, DVD-9, DVD-10, DVD-14, and DVD-18, CDs, laser discs, HD-DVDs, Blu-ray discs, magneto-optical, UMD, volumetric storage media such as holographic media and the like, including pre-recorded, recordable, and rewriteable versions of such formats.

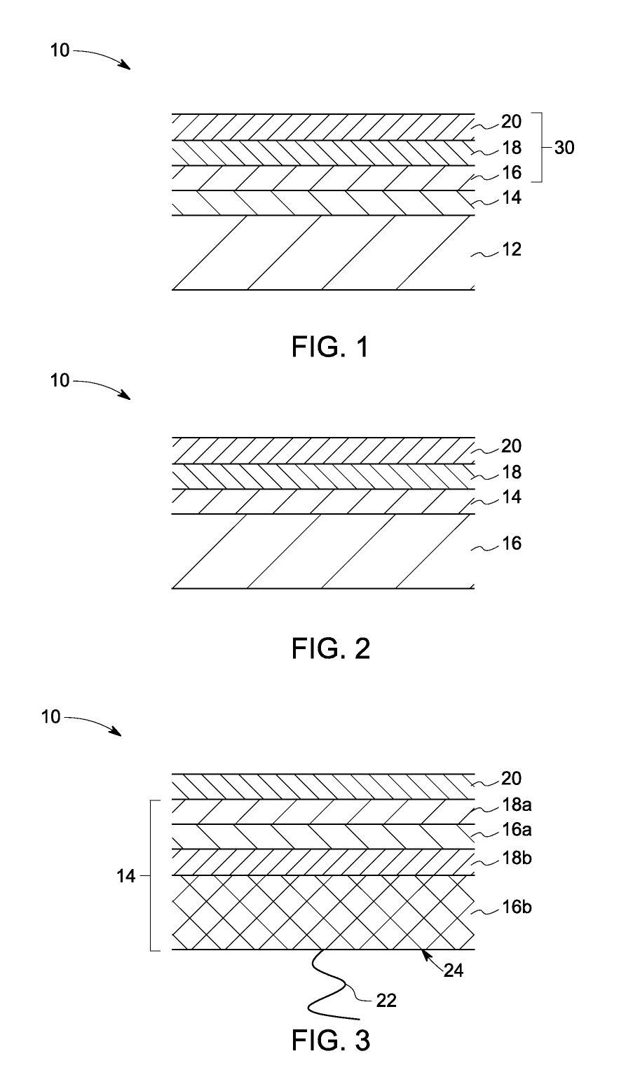

Storage layers, such as storage layer 18 (FIG. 1), in most optical storage devices are relatively consistent. For instance, in CDs and DVDs, a reflective layer is the storage layer and typically includes a series of bumps/pits that correspond to data. This data can be read by data reader systems, e.g., optical readers, where a laser light of a given wavelength (e.g., about 405 nm for HD-DVD and Blu-ray discs, about 635-650 nm for DVDs, and about 780 nm for CDs) is reflected off the surface of the storage layer to a detector keyed to receive the given wavelength of light, for instance, as the storage device is rotated. The bumps reflect the light differently than the other portions of the storage layer, and the pattern of those different reflections of light encodes the stored data.

In the case of conventional CDs and DVDs, the storage layer typically contains or is made from a reflective metallic material like aluminum. As shown in FIG. 1, disposed on opposite sides of storage layer 18 are a first layer 20 (e.g., typically an acrylic resin and/or polycarbonate substrate) that primarily protects the storage layer and a second layer 16 (e.g., typically a polycarbonate) which is substantially transparent to the given wavelength of light and thus through which the light from the optical reader is applied and reflected, and which can also function as another protective layer for storage layer 18. In some cases, there can be multiple storage layers on a single side of the substrate, back-to-back storage layers, bonding/adhesive layers, and/or additional optically transparent layers. Collectively, first or coating layer 20, storage layer 18, and second or optically transparent layer 16, as shown in FIG. 1, can represent the structure a conventional single-sided CD or DVD (30).

As shown in FIGS. 1-2, content access layer 14 can be disposed anywhere on optical storage device 10 between storage layer 18 and the data reader system energy (light) source. For instance, in FIG. 2, content access layer 14 is disposed between storage layer 18 and optically transparent layer 16, while in FIG. 1 content access layer 14 is disposed between the data reader system energy source and optically transparent layer 16, or both. In one preferred embodiment, based on FIG. 1, content access layer 14 is disposed on optically transparent layer 16 and thus between optically transparent layer 16 and the data reader system energy source (not shown). In another preferred embodiment, shown in FIG. 1, content access layer 14 is disposed between optically transparent layer 16 (disposed on storage layer 18) and a second optically transparent layer 12 that is disposed on an outermost surface of optical storage device 10 and can function to protect content access layer 14.

One aspect of the invention, shown in FIG. 2, is an optical storage device (10), such as a CD or a DVD, on which at least some limited-use data is stored and comprising storage layer 18 on which data is stored, content access layer 14 covering at least a portion of the data stored on the storage layer, coating layer 20 capable of protecting the storage layer and thus the data thereon, and, optionally but preferably, an optically transparent layer (16) through which the stored data from the storage layer can be accessed. In most embodiments, optically transparent layer 16 also functions as a protective layer but is disposed on a side of storage layer 18 opposite from the side on which coating layer 20 is disposed. In one embodiment, content access layer 14 and optically transparent layer 16 are combined to form a single optically transparent content access layer.

In another embodiment, shown in FIG. 3, an optical storage device (10), such as a DVD-9, on which at least some limited-use data is stored and comprising two storage layers 18a, 18b on which data is stored, two optically transparent layers 16a, 16b through which the stored data from storage layers 18a, 18b can be accessed, coating layer 20 capable of protecting the storage layers and thus the data thereon, and content access layer 14 covering at least a portion of the data stored on at least one of the storage layers. Although content access layer 14 is shown in FIG. 3 to be disposed between storage layer 18b and optically transparent layer 16b, this is merely one embodiment. Content access layer 14 can be disposed anywhere in optical storage device 10 between storage layer 18a and the energy-incident surface 24 of the most external optically transparent layer 16b. Content access layer 14 can be its own layer or can be coterminous, co-formed, or mixed together with one or more of optically transparent layers 16a, 16b. Wavelengths of energy 22 from optical storage device data reader system (not shown) can be used to access the data stored on storage layers 18a, 18b, at least some of which data can be covered by content access layer 14.

Content access layer 14, as described herein, may include a dye composition, which includes, but is not limited to: one or more dye compounds that exhibit a change in optical properties (e.g., photobleaching) upon exposure for a sufficient time and at a sufficient intensity to one or more wavelengths of energy (light) typically emitted by optical storage device data reader systems discussed above; a diluent/solvent; an oligomeric/polymeric binder/viscosity enhancer; optionally an optical activator for the dye compound (e.g., an electron donor, a dye compound bleaching activator, or the like, or a combination thereof); and other optional components known in the art, such as dispersants, salts, or the like, or combinations thereof.

The dye compound, as described herein, can be tailored to the specific wavelength of energy (light) typically emitted by the particular optical storage device data reader system; i.e., a dye compound for use on a DVD should exhibit a significant change in optical properties upon sufficient exposure to wavelengths of about 635-650 nm, while a dye compound for use on a HD-DVD or Blu-ray disc should exhibit a significant change in optical properties upon sufficient exposure to wavelengths of about 405 nm, and a dye compound for use on a CD should exhibit a significant change in optical properties upon sufficient exposure to wavelengths of about 780 nm. Examples of general classes of dye compounds meeting such requirements may include xanthenes, thiazines, oxazines, lactones, fulgides, spiropyrans, and diarylethenes. Examples of such dye compounds can include, but are not limited to, methylene blue, toluidine blue, Rose Bengal, erythrosine B, eosin Y, fluorone dyes, and those dyes and photoinitiators disclosed in U.S. Pat. Nos. 5,451,343 and 5,395,862, and in International Publication No. WO 97/21737.

In one embodiment, the dye compound contains a fluorone having the following formula:

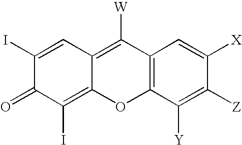

wherein W is hydrogen or a cyano group, X and Y are independently hydrogen or iodine, and Z is a hydroxyl group or a C₁-C₆ alkoxy group. In one aspect, the dye compound includes 2,4,5,7-tetraiodo-9-cyano-3-hydroxyxanthen-6-one or 2,4,5,7-tetraiodo-9-cyano-3-hydroxy-6-fluorone.

In another aspect, the dye compound contains a xanthene having the following formula:

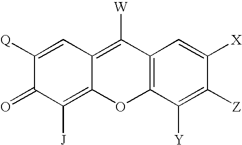

wherein W is hydrogen, a substituted phenyl group, a C₁-C₆ alkoxy group, or a cyano group, J, Q, X, and Y are independently hydrogen or iodine, and Z is a hydroxyl group, a C₁-C₆ alkoxy group, or a hydroxy-(C₁-C₆ alkoxy) group. In a preferred embodiment, the dye compound includes 5,7-diiodo-3-butoxy-6-fluorone or 4,5-diiodo-9-cyano-3-hydroxy-6-fluorone.

The change in optical properties of the dye compound/composition upon exposure to the energy source, e.g., from the optical data reader system for the particular optical storage device, can appear in any manner that results in the optical data reader system receiving a substantial change in the amount of energy detected. For example, where the dye is initially opaque and becomes more transparent upon exposure, there should be a substantial increase in the amount of light reflected off of the storage layer and transmitted through the content access layer and the optional optically transparent layer. Most dye compounds typically change (reduce) the amount of incident radiation detected by means of selective absorption at one or more given wavelengths of interest (corresponding to the type of optical storage device data reader system energy source). However, energy absorbance by the dye compound is not the only way to effect an optical property change.

Most types of optical storage device data reader system detectors are specifically designed to detect at least a certain intensity of radiation, reflected at a narrow set of wavelengths and/or frequencies surrounding the emitted wavelength(s) and/or frequency(ies), and usually in a particular polarization state. Therefore, besides absorbing the incident energy wavelength(s), the dye compound(s) and/or the dye composition may additionally or alternately accomplish any one or more of the following: change the polarization state of the incident energy; alter the frequency/wavelength of the incident energy; change the path of the incident energy, whether through reflection, refraction, scattering, or other means such that some portion of the energy is directed (and/or reflected off of the storage layer) away from the optical storage device data reader system detector.

For instance, in DVD-5 optical readers, the detector will typically read an error at least about 90% of the time when less than about 20% of the incident laser light reaches the detector, and the detector will typically read an error at least about 99% of the time when less than about 10% of the incident laser light reaches the detector. However, the detector will also typically read an error less than about 2% of the time when at least about 45% of the incident laser light reaches the detector. Thus, any dye compound/composition that can be alternated between these extremes of opacity and transparency at the given incident wavelength(s) upon exposure to energy of the same incident wavelength(s) is appropriate for use in content access layers, as described herein. Nevertheless, it is preferable to use dye compounds that are not threshold dye compounds for the incident energy wavelength(s). As used herein, “threshold dye compounds” mean dye compounds that do not exhibit a change in optical properties even upon repeated low-intensity exposure to incident energy at wavelength(s) typically emitted by conventional optical storage device data reader systems (e.g., from about 5 mW to about 10 mW for both CDs and DVDs). Without being bound to theory, it is believed that a threshold dye compound may experience desirable changes in optical properties upon exposure to incident energy of an intensity significantly higher (e.g., at least a factor of three higher, preferably at least a factor of five higher, and in some cases at least a factor of seven higher) than that emitted by current conventional optical storage device data reader systems at the given wavelength(s). As an example, the phthalocyanine and naphtholocyanine dyes disclosed in U.S. Patent Application Publication No. 2003/0081521 A1 are such threshold dyes, requiring an exposure at about 650 nm of more than 50 mW in intensity in order to bleach, and even then, those materials have been found instead to absorb energy at different wavelengths (on the order of about 700 nm, instead of the wavelength, about 650 nm, to which they were exposed).

The relative amount of dye compound in the dye composition of the content access layer will generally depend, at least in part, upon the initial opacity/color of the dye compound, the extent to which the dye compound changes optical properties (e.g., transparency/reflectivity) upon exposure to energy, and/or the thickness of the content access layer. In one embodiment, the dye composition can contain one or more dye compounds in a total amount ranging from about 0.01% to about 10% by weight, preferably from about 0.1% to about 6% by weight, more preferably from about 0.5% to about 5% by weight, for example from about 0.2% to about 3% by weight. In an alternate embodiment, the dye composition can contain one or more dye compounds in a total amount ranging from about 0.5 wt % to about 8%. In another alternate embodiment, the dye composition can contain one or more dye compounds in a total amount ranging from about 0.05% to about 0.5% by weight.

The use of an optional optical activator for the dye compound is preferred, e.g., to decrease the applied energy intensity and/or exposure time necessary to effect the change in optical properties of the dye compound. Optical dye activators used in the content access layers, as described herein, can be tailored to the particular dye compound and/or dye composition. Examples of optical activators, as described herein, may include, but are not limited to, trifunctional amines such as triethanolamine, triethanolamine triacetate, N,N-dimethylethylamine (DMEA), N,N-dialkylanilines such as N,N-dibutylaniline and DIDMA (N,N-dimethyl-2,6-diisopropylaniline), ethyl-para-(dimethylamino)benzoate, octyl-para-(dimethylamino)benzoate, 4-diethylamino-o-tolualdehyde, ETQC (3-[(1-ethyl-1,2,3,4-tetrahydro-6-quinolinyl)methylene]-2,3-dihydro-4H-1-benzopyran-4-one), DEAW (2,5-bis[[4-(diethylamino)phenyl]methylene]-(2E,5E)-cyclopentanone), 4,4′,4″-methylidynetris[N,N diethyl-3-methyl-benzenamine], and the like, and combinations thereof; difunctional amines such as diethanolamine, n-phenylglycine, lophine monomer (2,4,5-triphenyl-1,3-imidazole) or dimer, 2-mercaptobenzoxazole, and the like, and combinations thereof; monofunctional amines such as ethanolamine, aniline, and the like, and combinations thereof; photoinitiators such as 1,4,4-trimethyl-2,3-diazabicyclo[3.2.2]non-2-ene-2,3-dioxide; acrylate (polyester) amines such as those sold under the tradename EBECRYL™; borate salts such as n-butyrylcholine triphenyl-n-butyl borate, tetramethylammonium triphenylbutyl borate, tetramethylammonium trianisylbutyl borate, tetramethylammonium trianisyloctyl borate, and the like, and combinations thereof; iodonium salts such as OPPI ([4-(octyloxy)phenyl]phenyl-iodonium hexafluoroantimonate), bis(4-tert-butylphenyl)-iodonium triflate, (4-methoxyphenyl)-phenyliodonium triflate, (4-methyl-phenyl)-phenyliodonium triflate, DDPI (dodecyldiphenyl)odonium hexafluoroantimonate), (4-(2-tetradecanol)-oxyphenyl)iodonium hexafluoroantimonate, and the like, and combinations thereof; and the like; reaction/decomposition products thereof; and combinations thereof. Other useful optical activators can include, e.g., those disclosed in U.S. Pat. Nos. 5,451,343 and 5,166,041, as well as U.S. Patent Application Publication No. 2004/0152017 A1, the disclosures of each of which are hereby incorporated by reference.

When present, the relative amount of optical activator in the content access layer will generally depend, at least in part, upon the chemical nature of the dye compound, the relative amount of the dye compound, the initial opacity/color of the dye compound, the thickness of the content access layer, and/or the extent to which, and/or the speed with which, the dye compound changes transparency/reflectivity upon exposure to energy. In one embodiment, the content access layer contains one or more optical activators in a total amount ranging from about 0.1% to about 35% by weight, preferably from about 0.5% to about 25% by weight, more preferably from about 1% to about 15% by weight, for example from about 0.5% to about 9% by weight. In an alternate embodiment, the content access layer contains one or more optical activators in a total amount ranging from about 3% to about 12% by weight, preferably from about 2.5% to about 10% by weight. In another embodiment, the content access layer contains one or more optical activators such that the weight ratio of optical activators to dye compounds ranges from about 1:2 to about 30:1, preferably from about 1:1 to about 20:1, more preferably from about 3:1 to about 15:1, for example from about 5:1 to about 13:1.

In one embodiment, the content access layer may contain one or more dyes or pigments as a colorant in addition to the dye composition. In this case, the color of these dyes or pigments may remain as the dye composition is bleached by exposure to the drive laser.

As with the optional optical activators, the optional oligomeric/polymeric binder/viscosity enhancer(s), as described herein, can be tailored to the particular dye composition used in the content access layer. Examples of oligomeric/polymeric binder/viscosity enhancers can include, but are not limited to, polyacrylates such as oligomeric methyl methacrylates (e.g., Elvacite® 2008, commercially available from Lucite), poly(methyl methacrylate)s and/or ammonio methacrylates (e.g., those polymers and copolymers sold under the tradename EUDRAGIT®), poly(alkyl acrylate)s such as poly(methyl acrylate), poly(alkacrylate)s, poly(alkyl alkacrylate)s such as poly(ethyl methacrylate), poly(hydroxyalkyl acrylate)s, poly(hydroxyalkyl alkacrylates such as poly(2-hyroxyethyl methacrylate), and the like; poly(vinyl alcohol) and/or oligomeric vinyl alcohols; styrenics, including polystyrene, poly(hydroxystyrene)s, poly(styrene sulfonate)s, and copolymers thereof, such as styrene/butyl methacrylate copolymer, styrene/acrylonitrile copolymer, styrene/allyl alcohol copolymer, and styrene/maleic anhydride copolymer; poly(vinylpyrrolidone)s; poly(vinyl acetate); polyacetals such as poly(vinyl butyral); cellulosics, including hydroxyalkyl celluloses such as hydroxypropyl cellulose, hydroxyalkyl alkylcelluloses such as hydroxypropyl methylcellulose, and the like, as well as partially or completely esterified analogs thereof; and combinations or copolymers thereof.

The optional oligomeric/polymeric binder/viscosity enhancer(s), as described herein, may be present in any amount sufficient to allow satisfactory fabrication of the content access layer by techniques known in the art for depositing materials onto substrates. In one embodiment where the dye composition is spin-coated to form the content access layer, the dye composition can contain one or more oligomeric/polymeric binder/viscosity enhancers in a total amount ranging from about 3% to about 35% by weight, preferably from about 5% to about 25% by weight, for example from about 10% to about 20% by weight. In another embodiment where the dye composition is deposited by print-on-demand techniques such as ink-jet printing to form the content access layer, the dye composition can contain one or more oligomeric/polymeric binder/viscosity enhancers in a total amount ranging from about 0.5% to about 10% by weight, preferably from about 1% to about 5% by weight.

As with the optional oligomeric/polymeric binder/viscosity enhancer(s) and the optional optical activators, the optional diluent(s), as described herein, can advantageously be tailored to the particular dye composition used in the content access layer. Preferably, the diluent(s) used should not include those that significantly detrimentally affect the optical performance characteristics and/or the physico-chemical performance characteristics (e.g., uniformity, mechanical strength, etc.) of the optically transparent layer(s). As used herein, the phrase “significantly detrimentally affect,” in reference to a property, means negatively affect (in this case, decrease) that property by at least 20%, preferably by at least 15%, more preferably by at least 10%. Examples of useful diluents can include, but are not limited to, organic ethers such as propylene glycol monomethyl ether (PGME; e.g., sold under the tradename Dowanol® PM, commercially available from Dow), diethylene glycol monomethyl ether (DGME), diethylene glycol monobutyl ether (DGBE), and the like; hydroxy-functional solvents such as glycerol, ethanol, methanol, alkylene glycols such as ethylene glycol, propylene glycol, and polyethylene glycol, 1,2-hexanediol, 1,6-hexanediol, isopropanol, diacetone alcohol, and the like; dialkyl ketones such as acetone, methyl ethyl ketone, and the like; aromatics such as toluene, xylene, mesitylene, and the like; alkyl halides such as chloroform, bromoform, methylene chloride, methylene bromide, trichloromethane, and the like; and combinations thereof.

The optional diluent(s), as described herein, can be present in any amount sufficient to allow fabrication of the content access layer by techniques known in the art for depositing materials onto substrates. In one embodiment, the dye composition contains one or more diluents in a total amount ranging from about 30% to about 98% by weight, preferably from about 45% to about 90% by weight, for example from about 60% to about 85% by weight.

The dye composition may also contain other additives to aid in processing. These may include dispersants such as Disperbyk™ (BYK-Chemi, USA), surfactants such as Surfynol™ (Air Products, USA), leveling agents, anti-foaming agents, viscosity modifiers, and the like, to improve various properties of the dye composition.

The amounts of the dye compound(s) and optional optical activator(s) can be greater, and the amount of optional diluent(s) can be lower, than the embodiments described above. For example, an increase in the amount of dye compound(s) to up to about 20% by weight or higher can become necessary, especially when a high opacity is desired in the content access layer and/or when the number of exposures to the data reader system before the appropriate change in optical properties can be observed is desired to be more than the relatively small number discussed above.

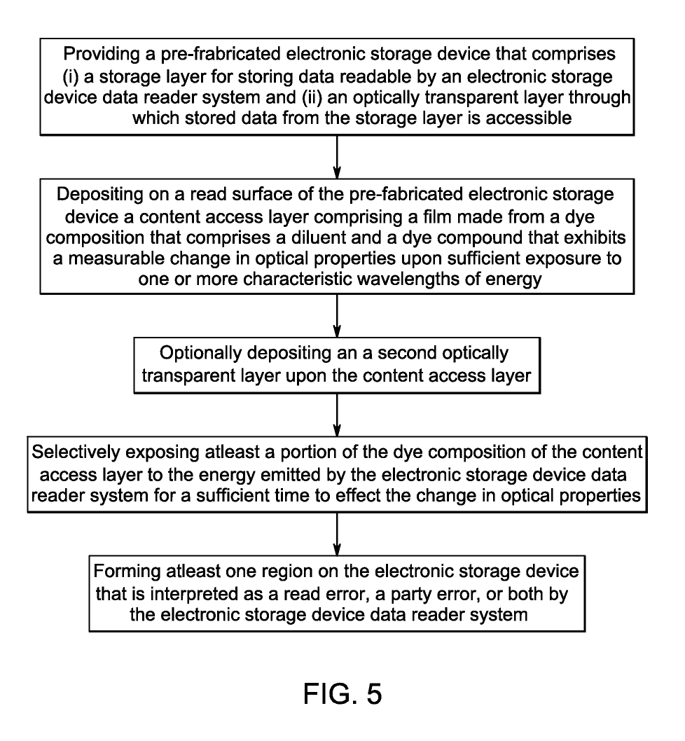

Another aspect of the invention relates to a method of fabricating a limited-use optical storage device, as described herein, for use with an optical storage device data reader system. In one embodiment, the method can include, but is not limited to, depositing on a read surface of pre-fabricated optical storage device 30, content access layer 14, as described herein, and optionally optically transparent (and protective) layer 12 upon content access layer 14. See, e.g., the flow chart of FIG. 5. The method also includes selectively exposing at least a portion of the dye composition of content access layer 14 to incident energy having one or more pre-selected wavelengths/frequencies for a sufficient time and at a sufficient intensity to effect a change in optical properties of the dye compound(s) in the exposed portion of the dye composition. This process can form at least one region on optical storage device 10 that is interpreted as a parity error and/or a read error by the optical storage device data reader system. The step of depositing content access layer 14 can be performed such that content access layer 14 is positioned between the optical storage device data reader system and storage layer 18 of pre-fabricated optical storage device 30 from which data is to be accessed, and typically proximal to another optically transparent layer 12, e.g., made from a polycarbonate material.

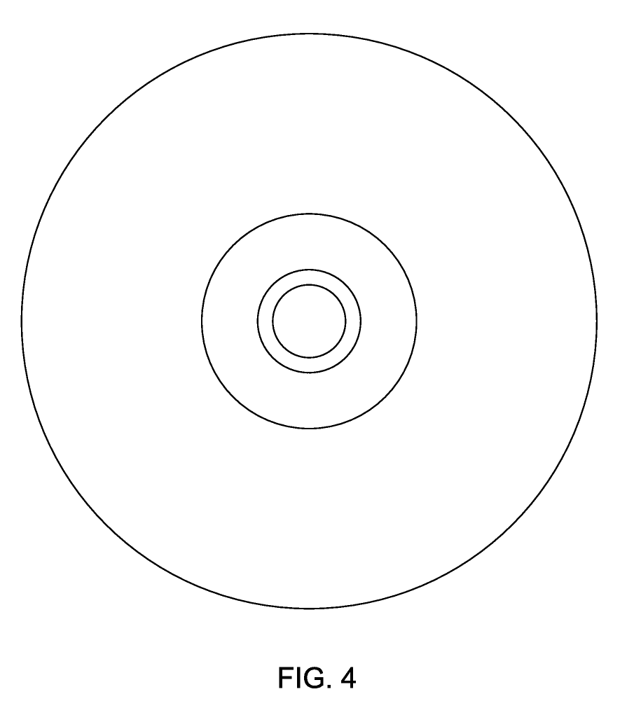

In a preferred embodiment, the selectively exposing step is accomplished by exposing content access layer 14 of optical storage device 10 to an energy source using a photomask tailored to obscure from the energy source the portion(s) of content access layer 14 where a change in optical properties are not desired and to allow exposure from the energy source to the portion(s) of content access layer 14 where a change in optical properties is desired. See, e.g., the photobleaching of all but three circular spots on the content access layer, as shown in FIG. 4. In such embodiments, the shape of the photomask can facilitate optical property changes in regions of any desired shape, e.g., circles, squares, astroids, rectangles, trapezoids, arcs, wedges, triangles, Reuleaux triangles, deltoids, cardioids, folia, nephroids, sectors, annuli, parallelograms, and the like, and combinations thereof.

The depositing of content access layer 14 (and optional second transparent/protective layer 12) is(are) achieved using a deposition process (or processes) that results in substantially no additional read errors. The term “additional read errors” means errors arising from the deposition process(es), which expressly does not include any read errors that were present, if any, in original pre-fabricated optical storage device 30 or that would have been present in the layers characteristic of a pre-fabricated optical storage device, e.g., without content access layer 14 and without optional second optically transparent layer 12, if present).

In one preferred embodiment, the depositing of content access layer 14 is accomplished by a technique other than an ink-jet printing technique. In another preferred embodiment, the depositing of content access layer 14 is achieved by spin coating the dye composition onto a read surface of pre-fabricated optical storage device 30. In another preferred embodiment, the depositing of content access layer 14 is achieved by spin coating the dye composition onto the entire read surface of pre-fabricated optical storage device 30.

In embodiments where the depositing of content access layer 14 is achieved by spin coating, a decreased amount of read errors (after bleaching) were observed for increased concentrations of dye compound(s), for spinning speeds that were relatively high, and for content access layer thicknesses that were relatively small (thin). Without being bound by theory, it is believed that increased dye compound concentration, increased spin speeds, and decreased layer thicknesses all positively affect the uniformity of the content access layer itself and/or of the dye compound dispersion amongst the content access layer.

If necessary or desired, after depositing content access layer 14 (but before depositing optional second transparent/protective layer 12, if present), any excess dye composition may be rinsed away with an appropriate solvent, e.g., the diluent(s) used in the dye composition, as described herein.

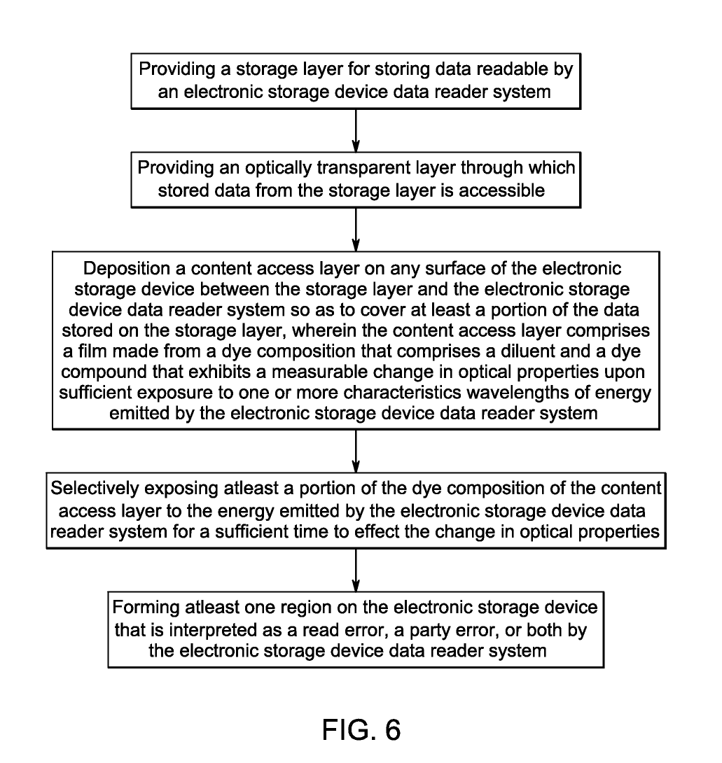

In another embodiment, the method can include, but is not limited to, the steps of: (i) providing optical storage device 30; (ii) depositing on optical storage device 30 content access layer 14, as described herein, between storage layer 18 and optically transparent layer 12 or 16; (iii) selectively exposing at least a portion of the dye composition of content access layer 14 to incident energy having one or more pre-selected wavelengths/frequencies for a sufficient time and at a sufficient intensity to effect a change in optical properties of the dye compound(s) in the exposed portion of the dye composition, and (iv) forming at least one region on optical storage device 30 that is interpreted as a read error and/or a parity error by the optical storage device data reader system. See, e.g., the flow chart of FIG. 6.

A preferred depositing process involves spin coating the dye compositions of content access layer 14 over an entire read surface of optical storage device 30. When the dye composition is originally colored and/or relatively opaque to a given wavelength of incident energy, subsequently one or more regions/spots are created by using a photomask to selectively bleach away the remainder of the color and/or opacity of the dye composition. In this embodiment, the one or more spots can cover specific regions of the storage layer. After one exposure or a predetermined number of (e.g., less than about 5) exposures to the energy emitted by the optical storage device data system reader, the transmissivity of content access layer 14 to the emitted energy should increase, allowing access to data on those specific regions of storage layer 18 that were previously inaccessible.

There are several ways in which to make data stored on storage layer 18 of limited-use content. In one embodiment, the one or more spots created can correspond to the area(s) of storage layer 18 on which one or more menus are stored. Upon a first or small number of initial plays of a DVD, for example, the menu(s) may be unreadable, causing the data reader system to indicate a read error, at which point the limited-use content, such as a trailer and/or advertisement, can be played without any choices by the user. However, after the initial number of plays of the DVD, when sufficient bleaching of the spots occurs, the menu(s) can be read and may give a user the ability to see the limited-use content again, if desired, or to skip the limited-use content entirely, if desired.

Alternately, the one or more spots created can be disposed over some specific area(s) of storage layer 18 that does not directly correspond to a menu or to any limited-use content. In this latter embodiment, upon noting a read error resulting from the unbleached dye composition, the DVD reader may be directed to a first portion of storage layer 18 on which the limited-use content data is stored. However, after the initial number of plays of the DVD, when sufficient bleaching of the spots occurs, the DVD reader may be directed to a second portion of storage layer 18, thus bypassing the limited-use content data. Thus, such a DVD may contain logic for detecting a change of optical state (or a change in read/parity error status) of the DVD and for directing the data reader system to the second portion of storage layer 18. A description of such logic, and a DVD containing such logic, can be found, for example, in U.S. Patent Application Publication No. 2003/0081521 A1.

In the following examples, dye compositions were applied to the read-side (laser-incident surface, represented, for example, by the bottom of layer 16 in FIG. 1) of DVDs to form respective content access layers 14. Content access layers 14 contained dye compounds/compositions that were found to be more sensitive (faster rate of photobleaching) than those described in the prior art, e.g., the phthalocyanines or naphtholocyanines disclosed in U.S. Patent Application Publication No. 2003/0081521 A1, which is incorporated by reference herein in its entirety.

Furthermore, the dye compositions were applied by various methods. In a preferred embodiment, the entire read surface of the DVD is spin-coated with the dye composition. Then regions of one or more spots are created by bleaching away undesired regions of dye with use of a photomask. This creates a variation of reflectivity in the coating while maintaining a uniform coating on the disc. It has been discovered that other deposition methods, e.g., ink-jet printing, often result in non-uniform coatings. Furthermore, the edges of the non-uniform coatings typically create an interface which can scatter or defocus the laser beam, and thus which can create unwanted errors during readout. In some cases, particularly common in ink-jet deposition methods, the errors resulting from non-uniform coating of dye compositions can be so severe as to prevent a detectable change in error state, even after sufficient bleaching of the dye compound.

It has further been discovered that coating layers containing certain thiazines such as methylene blue, when exposed to light in the presence of organic amines such as triethanolamine, will bleach (turn from relatively opaque/colored to relatively transparent/colorless) relatively rapidly. However, upon removal of such a thiazine coating composition from the light source, the color of the dye will return (it will revert back to approximately its prior opacity/blue color) over a period of hours to days. This bleaching reversibility is undesirable in some embodiments. In contrast, it has also been discovered that, under similar conditions, xanthene dyes such as 2,4,5,7-tetraiodo-9-cyano-3-hydroxyxanthen-6-one and 5,7-diiodo-3-butoxy-6-fluorone are not similarly reversibly bleachable. In some embodiments, the method of accelerated development of photosensitive materials disclosed in U.S. Patent Application Publication No. 2004/0152127 A1, which is incorporated by reference in its entirety, can be used to evaluate dye compositions for content access layers, as described herein.

### Example 1

A series of DVDs were coated with a dye composition containing a methyl methacrylate-based binder (Elvacite® 2008) and from about 0.1% to about 2% of a photobleachable dye compound. Samples were exposed to white light from a broad spectrum 6.5-Watt LS-1 Tungsten halogen lamp (unfocused) via a fiber optic reflective probe (connected to an Ocean Optics USB 2000 Spectrometer). Reflectance spectra were captured as a function of exposure time, with two dyes in particular showing relatively rapid bleaching behavior (HWSands MSA3367 and diarylethene).

### Example 2

A series of DVDs were spin-coated on a read surface with a dye composition containing a methyl methacrylate-based binder (Elvacite® 2008) and from about 1% to about 4% of a photobleachable dye. Two dyes included methylene blue and aluminum phthalocyanine chloride. Regions of the coated disc were exposed to a 650 nm laser diode using various laser powers while spinning the disc from about 2 to about 30 rpm. UV-Vis spectra including % transmission (% T) at about 650 nm and at about 780 nm of the exposed and unexposed regions were collected. In the case of the methylene blue coated disc, exposure to the red laser resulted in a significant increase in reflectance at about 650 nm (about 22% reflectivity after exposure to about 73 mW at a spin speed of about 2 rpm).

### Example 3

A diarylethene dye was dissolved (at about 0.5 wt % concentration) in a UV-curable adhesive typically used to manufacture a DVD. Regions of the disc were exposed to a 650 nm laser diode using varying laser powers while spinning the disc from about 2 to about 30 rpm. The dye in regions of the disc are effectively bleached using laser powers greater than about 5 mW, which is a laser power that is commonly achievable in consumer DVD players and drives.

### Example 4

A diarylethene dye was dissolved in a dye composition containing a methyl methacrylate-based binder (Elvacite® 2008) and a Dowanol PM solution and was coated onto the read surface of a DVD. The disc was spun at about 10 rpm and exposed to a 650 nm laser diode at about 50 mW. Under those conditions, stripes of bleached dye are visible where the disc had been exposed to the laser.

### Example 5

A read surface of a DVD was spin-coated with a dye composition containing a methyl methacrylate-based binder (Elvacite® 2008) and a diarylethene dye. The disc was first exposed to visible light (using a 100 W halogen lamp with a 400 nm cutoff filter) to effectively bleach the diarylethene dye to its colorless form. The disc was tested in an electrical tester (Lite-On SOHW 1673 DVD-RW drive using Kprobe software). PO parity errors were measured. The disc was then exposed to UV light using a photomask to create first three 3 mm-diameter spots and second to three 2 mm-diameter spots to create regions in the disc coating in which the diarylethene dye was to be converted to its blue colored form. PO parity errors were measured after each exposure to UV light. Then, the discs were exposed to visible light to bleach the dye, thereby removing the blue spots. PO parity errors were then measured again. From the results of this experiment, it is believed that: 1) the blue spots of both diameters created by the diarylethene dye create errors (PO errors affect the playability of a DVD); and 2) bleaching of the dye to remove the blue spots reduced (and in some cases substantially eliminated) the incidence of PO errors.

One skilled in the art may appreciate that, if PO errors are located at appropriate sectors (logical block addresses), the playability of the disc may be affected. In some cases, if enough PO errors are present or if the PO errors occur at or near the table of contents region of the disc, the disc may not be bootable. Then, upon bleaching of the disc and removal of the PO errors, the disc will become bootable and playable.

### Example 6

A DVD containing a content access layer was prepared as in Example 5 with a movie stored thereon. Three spots were created in the content access layer. The disc was then played in a Sony DVP-S360 DVD Player, repeating playback of sections of the movie for one day, two days, three days, and seven days (corresponding to 37 plays, 82 plays, 121 plays, and 282 plays, respectively). This experiment demonstrates that the dye can be bleached using an ordinary DVD player during playback of the movie. It was also observed that, with the change in color of the spots, a change in error state (magnitude of PO errors) is noted. When the error state changes, in one embodiment, the playback logic can be altered, e.g., as described in US2003/0081521.

### Example 7

A series of DVDs were coated with a dye composition containing: a methyl methacrylate-based binder (Elvacite® 2008); a Dowanol PM solution; an optical dye activator selected from N-phenylglycine, triethanolamine, Ebecryl™ acrylate-amine, triphenylbutylborate n-butyrylcholine, OPPI, and combinations thereof; and a dye compound having the following formula:

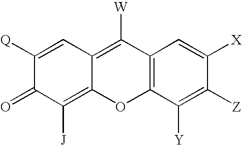

wherein W is hydrogen, a substituted phenyl group, a C₁-C₆ alkoxy group, or a cyano group, J, Q, X, and Y are independently hydrogen or iodine, and Z is a hydroxyl group, a C₁-C₆ alkoxy group, or a hydroxy-(C₁-C₆ alkoxy) group. The dye compositions were exposed to a white light source as in Example 1. Transmission (% T) at 650 nm was measured as a function of exposure time. A variety of bleaching response times were obtained from the various samples. Bleaching times ranged from hours to less than 1 minute. In comparison, the diarylethene dye, without an optical activator, exhibited a bleaching time on the order of about 400 seconds.

### Example 8

A series of DVDs were coated with a dye composition containing a methyl methacrylate-based binder (Elvacite® 2008), Dowanol PM as diluent, and from about 0.5% to 3% of 2,4,5,7-tetraiodo-9-cyano-3-hydroxyxanthen-6-one (H-Nu 635, Spectragroup, USA) based on the total weight of the polymer solution. Samples were exposed to white light from a Tungsten lamp via a fiber optic reflective probe (Ocean Optics). Reflectance spectra were captured as a function of exposure time. Tables 1-3 below show dye compositions and 650-nm bleaching information. In Tables 1-2 below, the dye composition further contained about 20 wt % of Elvacite® 2008 oligomeric methyl methacrylate binder.

Particularly preferable results are indicated by dye compositions that have a relatively low initial % T (preferably an initial % T of 20 or below), a final % T above 45, a relatively short bleaching half-time, a relatively high initial slope, and a relatively short time to 45% R. Such preferable results can be seen, e.g., in compositions 1, 7, 11, 16, 19, 24, 25, 27, 31, 32, and 43. Other results of interest can be seen, e.g., in compositions 17, 21, 30, 34, 47, and 49.

TABLE 1

| | | | | | | | | | bleach | | time to |
|---|---|---|---|---|---|---|---|---|---|---|---|
| | wt % | wt % | wt % | wt % | wt % | wt % | initial | final | ½ time | initial | 45% R |
| Comp. # | Dye | Borate | OPPI | TEA | NPG | P115 | % T | % T | [sec] | slope | [sec] |
| 1 | 0.5 | 3 | 0.5 | 3 | 3 | 0.5 | 19 | 81 | 62 | 0.5 | 52 |
| 2 | 0.5 | 3 | 3 | 3 | 0.5 | 3 | 66 | 94 | 51 | 0.27 | N/A |
| 3 | 1.5 | 0.5 | 3 | 0.5 | 0.5 | 3 | 15 | 43 | 297 | 0.05 | N/A |
| 4 | 0.5 | 0.5 | 3 | 0.5 | 3 | 3 | 65 | 95 | 41 | 0.36 | N/A |
| 5 | 1.5 | 3 | 0.5 | 3 | 0.5 | 0.5 | 11 | 43 | 133 | 0.12 | N/A |
| 6 | 1.5 | 0.5 | 0.5 | 3 | 3 | 3 | 13 | 69 | 205 | 0.14 | 287 |
| 7 | 0.5 | 3 | 0.5 | 0.5 | 3 | 3 | 19 | 90 | 51 | 0.68 | 31 |
| 8 | 1.5 | 0.5 | 3 | 3 | 0.5 | 0.5 | 15 | 73 | 153 | 0.19 | 164 |
| 9 | 1.5 | 3 | 0.5 | 0.5 | 0.5 | 3 | 12 | 77 | 532 | 0.06 | 553 |
| 10 | 0.5 | 3 | 3 | 0.5 | 0.5 | 0.5 | 70 | 95 | 21 | 0.6 | N/A |
| 11 | 1.5 | 3 | 3 | 0.5 | 3 | 0.5 | 18 | 87 | 72 | 0.48 | 51 |
| 12 | 0.5 | 0.5 | 3 | 3 | 3 | 0.5 | 66 | 86 | 31 | 0.31 | N/A |
| 13 | 1 | 1.75 | 1.75 | 1.75 | 1.75 | 1.75 | 11 | 80 | 358 | 0.1 | 338 |
| 14 | 1.5 | 0.5 | 0.5 | 0.5 | 3 | 0.5 | 12 | 83 | 143 | 0.25 | 123 |
| 15 | 0.5 | 0.5 | 0.5 | 0.5 | 0.5 | 0.5 | 29 | 86 | 185 | 0.16 | 52 |
| 16 | 1.5 | 3 | 3 | 3 | 3 | 3 | 12 | 80 | 51 | 0.67 | 51 |
| 17 | 0.5 | 0.5 | 0.5 | 3 | 0.5 | 3 | 20 | 86 | 113 | 0.29 | 62 |
| 18 | 0.5 | 0 | 0.5 | 0.5 | 3 | 0 | 22 | 88 | 122 | 0.27 | 82 |

P115 = Ebecryl ® acrylate amine P115;
% T = % transmission;
initial % T = before bleaching;
final % T = after bleaching;
initial slope = slope of % T vs. bleaching time curve as t →0;
45% R = point at which 45% of the incident 650 nm light is reflected and detected by the Ocean Optics spectrometer.

TABLE 2

| | | | | | | | | | bleach | | time to |
|---|---|---|---|---|---|---|---|---|---|---|---|
| | wt % | wt % | wt % | wt % | wt % | wt % | initial | final | ½ time | initial | 45% R |
| Comp. # | Dye | Borate | OPPI | TEA | NPG | DIDMA | % T | % T | [sec] | slope | [sec] |
| 19 | 0.5 | 3 | 0 | 0 | 0 | 0 | 14 | 86 | 50 | 0.72 | 40 |
| 20 | 0.5 | 0 | 0 | 3 | 0 | 0 | 42 | 82 | 118 | 0.17 | 8 |
| 21 | 0.5 | 0 | 0 | 0 | 3 | 0 | 14 | 82 | 77 | 0.44 | 69 |
| 22 | 0.5 | 0 | 0 | 0.5 | 3 | 0 | 16 | 85 | 141 | 0.24 | 101 |
| 23 | 0.5 | 0 | 0 | 0 | 0 | 3 | 38 | 56 | 296 | 0.03 | 184 |
| 24 | 0.5 | 3 | 0 | 0.5 | 3 | 0 | 13 | 93 | 23 | 1.75 | 19 |
| 25 | 0.5 | 3 | 0 | 0 | 3 | 0 | 15 | 94 | 72 | 0.54 | 47 |
| 26 | 0.5 | 0 | 0 | 0.5 | 0 | 3 | 65 | 73 | 149 | 0.03 | N/A |
| 27 | 0.5 | 2 | 0 | 0.5 | 2 | 0 | 19 | 88 | 49 | 0.70 | 32 |
| 28 | 0.5 | 2 | 0 | 0 | 2 | 0 | 11 | 82 | 112 | 0.32 | 105 |
| 29 | 0.5 | 1 | 0 | 0 | 1 | 0 | 16 | 79 | 178 | 0.18 | 154 |
| 30 | 0.5 | 3 | 0 | 0 | 1 | 0 | 13 | 81 | 86 | 0.39 | 77 |
| 31 | 0.5 | 3 | 0 | 0.5 | 1 | 0 | 14 | 86 | 70 | 0.51 | 42 |
| 32 | 1 | 3 | 0 | 0.5 | 3 | 0 | 14 | 80 | 65 | 0.51 | 59 |
| 33 | 1 | 3 | 0 | 0 | 3 | 0 | 12 | 88 | 150 | 0.25 | 121 |
| 34 | 1 | 2 | 0 | 0.5 | 3 | 0 | 14 | 76 | 77 | 0.40 | 78 |
| 35 | 1 | 2 | 0 | 0 | 3 | 0 | 12 | 81 | 194 | 0.18 | 181 |
| 36 | 1 | 1 | 0 | 0.5 | 3 | 0 | 13 | 74 | 92 | 0.33 | 97 |

TABLE 3

| | | | | | | | | time to |
|---|---|---|---|---|---|---|---|---|
| | wt % | wt % | wt % | wt % | wt % | initial | final | 45% R |
| Comp. # | Dye | Borate | TEA | NPG | 2008 | % T | % T | [sec] |
| 41 | 3 | 1 | 0.5 | 2 | 10 | 29 | 86 | 8 |
| 42 | 3 | 1 | 3 | 2 | 20 | 17 | 80 | 157 |
| 43 | 3 | 6 | 3 | 6 | 20 | 17 | 97 | 26 |
| 44 | 2 | 3.5 | 1.75 | 4 | 15 | 24 | 97 | 17 |
| 45 | 1 | 1 | 3 | 6 | 10 | 56 | 99 | N/A |
| 46 | 1 | 1 | 0.5 | 6 | 20 | 23 | 101 | 11 |
| 47 | 1 | 6 | 3 | 2 | 10 | 60 | 95 | N/A |
| 48 | 1 | 6 | 0.5 | 2 | 20 | 28 | 95 | 4 |
| 49 | 3 | 6 | 0.5 | 6 | 10 | 22 | 97 | 13 |

2008 = Elvacite ® 2008 oligomeric methyl methacrylate.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An optical storage device, on which at least some limited-use data is stored, comprising:
a storage layer for storing data readable by an optical storage device data reader system;
a content access layer covering at least a portion of the data stored on the storage layer and made from a dye composition that comprises a dye compound and that exhibits a measurable change in optical properties upon sufficient exposure to one or more characteristic wavelengths of energy; and
an optically transparent layer through which stored data from the storage layer is accessible,
wherein the dye compound comprises a xanthene, a thiazine, an oxazine, a fluorone, or a combination thereof.

2. The optical storage device of claim 1, wherein the dye composition comprises an optical activator and wherein the dye compound comprises a xanthene having the following formula: 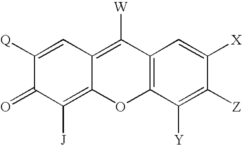
where W is hydrogen, a substituted phenyl group, a C₁-C₆ alkoxy group, or a cyano group, J, Q, X, and Y are independently hydrogen or iodine, and Z is a hydroxyl group, a C₁-C₆ alkoxy group, or a hydroxy-(C₁-C₆ alkoxy) group.

3. The optical storage device of claim 2, wherein the dye compound comprises 5,7-diiodo-3-butoxy-6-fluorone, 4,5-diiodo-9-cyano-3-hydroxy-6-fluorone, 2,4,5,7-tetraiodo-9-cyano-3-hydroxy-6-fluorone, or combinations thereof.

4. The optical storage device of claim 1, wherein the content access layer and the optically transparent layer are combined together.

5. The optical storage device of claim 1, wherein the content access layer is present in its own layer and further comprises a diluent.

6. The optical storage device of claim 5, wherein the content access layer is disposed between the storage layer and the optically transparent layer.

7. The optical storage device of claim 5, wherein the optically transparent layer is disposed between the content access layer and the storage layer.

8. The optical storage device of claim 7, wherein a second optically transparent layer is disposed over the content access layer.

9. The optical storage device of claim 1, wherein the optical storage device comprises a DVD or a CD.

10. The optical storage device of claim 9, wherein the dye compound exhibits the measurable change in optical properties upon not more than about 100 seconds of direct exposure to a light source emitting wavelengths from about 635 nm to about 650 nm at an intensity from about 5 mW to about 10 mW.

11. The optical storage device of claim 1, wherein the optical storage device comprises an HD-DVD, a Blu-ray disc, or a volumetric storage medium.

12. The optical storage device of claim 1, wherein the dye composition is substantially free from threshold dyes.

13. A method of fabricating a limited-use optical storage device comprising:
(a) depositing a content access layer on a read surface of a pre-fabricated optical storage device that comprises:
(i) a storage layer for storing data readable by an optical storage device data reader system; and
(ii) an optically transparent layer through which stored data from the storage layer is accessible,
wherein the content access layer is made from a dye composition comprising a dye compound and that exhibits a measurable change in optical properties upon sufficient exposure to one or more characteristic wavelengths of energy;
(b) optionally depositing a second optically transparent layer upon the content access layer;
(c) selectively exposing at least a portion of the dye composition of the content access layer to the energy emitted by the optical storage device data reader system for a sufficient time to effect the change in optical properties; and
(d) forming at least one region on the optical storage device that is interpreted as a read error, a parity error, or both by the optical storage device data reader system,
wherein the dye compound exhibits the measurable change in optical properties upon not more than about 100 seconds of direct exposure to a light source emitting wavelengths from about 635 nm to about 650 nm at an intensity from about 5 mW to about 10 mW.

14. The method of claim 13, wherein the depositing of the content access layer is accomplished by spin-coating the dye composition and allowing a film to form.

15. The method of claim 13, wherein the dye composition comprises an optical activator and wherein the dye compound comprises a xanthene, a thiazine, an oxazine, a fluorone, or a combination thereof.

16. The method of claim 15, wherein the dye compound comprises 5,7-diiodo-3-butoxy-6-fluorone, 4,5-diiodo-9-cyano-3-hydroxy-6-fluorone, 2,4,5,7-tetraiodo-9-cyano-3-hydroxy-6-fluorone, or combinations thereof.

17. The method of claim 13, wherein the dye composition is substantially free from threshold dyes.

18. The method of claim 13, wherein the pre-fabricated optical storage device comprises a DVD.

19. The method of claim 13, wherein the pre-fabricated optical storage device comprises a CD.

20. The method of claim 13, wherein the pre-fabricated optical storage device comprises an HD-DVD, a Blu-ray disc, or a volumetric storage medium.

21. A method of fabricating a limited-use optical storage device comprising:
providing a storage layer for storing data readable by an optical storage device data reader system;
providing an optically transparent layer through which stored data from the storage layer is accessible;
depositing a content access layer on any surface of the optical storage device between the storage layer and the optical storage device data reader system so as to cover at least a portion of the data stored on the storage layer,
wherein the content access layer is made from a dye composition that comprises a dye compound and that exhibits a measurable change in optical properties upon sufficient exposure to one or more characteristic wavelengths of energy emitted by the optical storage device data reader system;
selectively exposing at least a portion of the dye composition of the content access layer to the energy emitted by the optical storage device data reader system for a sufficient time to effect the change in optical properties; and
forming at least one region on the optical storage device that is interpreted as a read error, a parity error, or both by the optical storage device data reader system,
wherein the dye compound exhibits the measurable change in optical properties upon not more than about 100 seconds of direct exposure to a light source emitting wavelengths from about 635 nm to about 650 nm at an intensity from about 5 mW to about 10 mW.

22. The method of claim 21, wherein the depositing of the content access layer is accomplished by spin-coating between the storage layer and the optically transparent layer.

23. The method of claim 21, wherein the dye composition further comprises an optical activator and wherein the dye compound comprises a xanthene having the following formula: 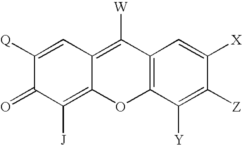
where W is hydrogen, a substituted phenyl group, a C₁-C₆ alkoxy group, or a cyano group, J, Q, X, and Y are independently hydrogen or iodine, and Z is a hydroxyl group, a C₁-C₆ alkoxy group, or a hydroxy-(C₁-C₆ alkoxy) group.

24. The method of claim 23, wherein the dye compound comprises 5,7-diiodo-3-butoxy-6-fluorone, 4,5-diiodo-9-cyano-3-hydroxy-6-fluorone, 2,4,5,7-tetraiodo-9-cyano-3-hydroxy-6-fluorone, or combinations thereof.

25. The method of claim 21, wherein the dye composition is substantially free from threshold dyes.

26. The method of claim 21, wherein the optical storage device comprises a DVD.

27. The method of claim 21, wherein the optical storage device comprises a CD.

28. The method of claim 21, wherein the optical storage device comprises an HD-DVD, a Blu-ray disc, or a volumetric storage medium.
